(19) United States
(12) Patent Application Publication
(10) Pub. No.: US 2019/0180624 A1
(43) Pub. Date: Jun. 13, 2019

(54) PEDESTRIAN SIDE COLLISION WARNING SYSTEMS AND METHODS

(71) Applicant: Novateur Research Solutions LLC, Leesburg, VA (US)

(72) Inventors: Khurram Hassan-Shafique, Ashburn, VA (US); Zeeshan Rasheed, Herndon, VA (US)

(73) Assignee: Novateur Research Solutions LLC, Leesburg, VA (US)

(21) Appl. No.: 16/268,481

(22) Filed: Feb. 5, 2019

Related U.S. Application Data
(63) Continuation of application No. 15/471,840, filed on Mar. 28, 2017.
(60) Provisional application No. 62/410,053, filed on Oct. 19, 2016.

(51) Int. Cl. G08G 1/16; G08G 1/005; G06T 7/70; G06T 7/20

(52) U.S. Cl. CPC G08G 1/166; G08G 1/005; G08G 1/164; G06T 7/70; G06T 7/20; H04N 5/247; G06T 2207/30196; G06T 2207/20076; G06T 2207/30261; G06T 2207/10048; G06T 2207/10016

(57) ABSTRACT

Systems and methods for alerting a human operator of a predicted side collision of a transit bus with a pedestrian or bicyclist, including receiving range scanner data from a range scanner located at a first side of the bus covering a first area on the first side of the bus, receiving image data from a sensor located at the first side of the bus and covering an area along the first side of the bus that overlaps the first area, detecting and tracking the pedestrian or bicyclist based on the range scanner data and the image data, estimating a likelihood of collision between the pedestrian or bicyclist and the first side of the bus based on the tracking of the pedestrian or bicyclist, and presenting an alert to the human operator in response to a determination that a warning should be presented based on the estimated likelihood of collision.

### CROSS-REFERENCE TO RELATED APPLICATIONS

This application is a continuation of and claims priority under 35 U.S.C. § 120 to U.S. patent application Ser. No. 15/471,840, filed on Mar. 28, 2017 and entitled “Pedestrian Collision Warning System for Vehicles,” which claims the benefit of priority from U.S. Provisional Patent Application Ser. No. 62/410,053, filed on Oct. 19, 2016 and entitled “System for Pedestrian and Cyclist Detection and Collision Avoidance for Large Vehicles,” each of which are incorporated herein by reference in their entireties.

### FIELD OF THE DISCLOSURE

The present disclosure relates to a pedestrian collision warning system for vehicles. In one embodiment, a transit bus detects pedestrians or cyclists and warns a bus operator to avoid collisions.

### BACKGROUND OF THE DISCLOSURE

The background of the disclosure section is merely to present the context of the disclosure and the known problems and difficulties of the prior art. However, the statements herein are not admitted as prior art against the present disclosure.

Pedestrians represent a considerable portion of traffic-related (cars, trucks and transit) injuries and deaths on our nation's highways. In 2008, 4,378 pedestrians were killed and 69,000 were injured in traffic crashes in the United States. This represents 12% and 3%, respectively, of all the traffic fatalities and injuries. The majority of these fatalities occurred in urban areas (72%) where pedestrians, cyclists, and vehicular traffic, including transit buses, tend to co-mingle. Although the pedestrian injuries and fatalities are few in number relative to other collision types, bus collisions involving pedestrians and cyclists usually carry high cost (injury claims), attract negative media attention, and have the potential to create a negative public perception of transit safety. These reasons along with increasing pedestrian traffic in urban areas and the rise of “distracted walking” of pedestrians using electronic devices, and recent efforts to promote public transit as a more sustainable and environmental friendly transportation alternative, has led transit agencies to pay substantial attention on pedestrian safety.

It has been determined by many studies that a large percentage of pedestrian accidents involving transit buses are avoidable if the threat is detected early and the driver and/or pedestrians are alerted accordingly. Therefore, there is an increased demand of economically viable, accurate, and durable sensor technologies that can detect pedestrians and cyclists, estimate threat of collision, and present this information to the drivers (and optionally to pedestrians and cyclists) in a timely fashion. Effective collision warning systems (CWS) for transit buses can address many of the incidences related to pedestrians and have the potential to save both the lives and costs.

There are some sensor systems and collision warning technologies currently available, however, there are significant concerns about the reliability and questions about their performance in challenging scenarios that are typical in transit bus operations in urban environment. Accident data has shown that most of the transit bus accidents involving pedestrians occur either near the bus stops as the bus is approaching or leaving the bus stop, or as the bus is making a turn. However existing collision warning technologies are more catered towards detecting frontal collisions that are typical in highway settings. Moreover, many of the existing pedestrian detection technologies heavily rely on the use of visual sensors that have limited operating conditions in terms of lighting and weather conditions.

The two primary limitations of the current pedestrian detection technologies for transit buses are: i) the inability of the sensors and detection system to perform in different environmental conditions, and ii) the inability of the detection and the threat warning generation system to operate with high-enough accuracy so that the false alarms do not become a nuisance factor for the driver/operator that they start to ignore the alerts.

The existing technologies use a variety of sensors for pedestrian detection and collision avoidance, each with its own benefits, limitations, and performance tradeoffs. Almost all of the commercially available technologies for pedestrian and cyclist detection exploit image features obtained from electro-optical sensors (especially from color or monochrome video sensors). For example, MobilEye® and SafetyShield Systems Ltd, both of which employ monocular cameras to detect pedestrians around the vehicle. The performance of these systems suffer significantly with environmental and lighting conditions. In addition to challenges with different environmental conditions, the monocular camera-based systems are unable to measure the distance/relative position of the pedestrians with respect to the bus and therefore cannot make accurate collision threat assessments. Fusion Processing's CycleEye® system combines radar sensors with the visual sensor, however, due to known limitations of radar sensors for pedestrian detection, their system is only used for detection of moving cyclists around the bus. [MD+05] uses LIDAR sensors for collision warning, however, the system is unable to distinguish between pedestrians and other objects like trees, poles, water splashes etc.

[MD+05] is described by C. Mertz, D. Duggins, J. Gowdy, J. Kozar, R. MacLachlan, A. Steinfeld, A. Suppe, C. Thorpe, and C. Wang, “Collision Warning and Sensor Data Processing in Urban Areas,” Intl. Conf. on ITS telecommunications, 2005.

Although transit buses are used as a specific example, the ideas disclosed in this application are broadly applicable to other situations such as: any vehicle turning at an intersection or changing lanes (including airplanes turning at runways), and any vehicle entering or exiting a congested area (such as a commercial transport truck entering a loading area).

### SUMMARY OF THE DISCLOSURE

In one embodiment, a collision warning system for vehicles includes four major modules: a detection, tracking, and localization (DTL) laser module, a detection, tracking, and localization (DTL) thermal module, a fusion module, and a collision prediction module. The detection, tracking, and localization (DTL) laser module receives laser data from a first laser range scanner, and generates laser data output, wherein the first laser range scanner covers a first laser area. The detection, tracking, and localization (DTL) thermal module receives thermal data from a first thermal video sensor, and generates thermal data output, wherein the first thermal video sensor covers a first thermal area, and wherein the first thermal area overlaps with at least a portion of the first laser area to create a first overlap area. The fusion module receives the laser data output and the thermal data output, fuses the laser data output and the thermal data output, and generates a situational awareness map. The collision prediction module receives the situational awareness map, predicts a collision between a detected object and a vehicle, and warns an operator regarding the predicted collision.

### BRIEF DESCRIPTION OF THE DRAWINGS

FIG. 1 is a schematic block diagram of a vehicle including sensors and an expert system of one embodiment of the present disclosure.

FIG. 2 is a schematic block diagram of the vehicle illustrating coverage of various sensors of one embodiment of the present disclosure.

FIG. 3 is a schematic block diagram of components of the collision avoidance system of one embodiment of the present disclosure.

FIG. 4 is a schematic block diagram of an exemplary and non-limiting list of sensors.

FIG. 5 is a schematic block diagram illustrating some exemplary modules of an expert system of one embodiment of the present disclosure.

FIG. 6 illustrates a flowchart of one embodiment of an expert system.

FIG. 7 illustrates accidents that may occur as a transit bus pulls (a) into a bus stop or (b) out of a bus stop.

FIG. 8 illustrates accidents that may occur at an intersection while a bus is turning (a) to the right, or (b) to the left.

FIG. 9 illustrates a perspective view of a sensor configuration described in FIGS. 1 and 2.

FIG. 10 illustrates one embodiment of the collision warning system described in FIGS. 3-6.

### DETAILED DESCRIPTION

Reference will now be made in detail to embodiments of the present disclosure, examples of which are illustrated in the accompanying drawings, wherein like reference numerals refer to the like elements throughout the several views. In this regard, the present embodiments may have different forms and should not be construed as being limited to the descriptions set forth herein. Accordingly, the embodiments are merely described below, by referring to the figures, to explain aspects of the present description. Terms used herein are for descriptive purposes only and are not intended to limit the scope of the disclosure. The terms “comprises” and/or “comprising” are used to specify the presence of stated elements, steps, operations, and/or components, but do not preclude the presence or addition of one or more other elements, steps, operations, and/or components. The terms “first,” “second,” and the like may be used to describe various elements, but do not limit the elements. Such terms are only used to distinguish one element from another. These and/or other aspects become apparent and are more readily appreciated by those of ordinary skill in the art from the following description of embodiments of the present disclosure, taken in conjunction with the accompanying drawings.

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than the broadest meaning understood by skilled artisans, such a special or clarifying definition will be expressly set forth in the specification in a definitional manner that provides the special or clarifying definition for the term or phrase.

For example, the following discussion contains a non-exhaustive list of definitions of several specific terms used in this disclosure (other terms may be defined or clarified in a definitional manner elsewhere herein). These definitions are intended to clarify the meanings of the terms used herein. It is believed that the terms are used in a manner consistent with their ordinary meaning, but the definitions are nonetheless specified here for clarity.

A/an: The indefinite articles “a” and “an” as used herein mean one or more when applied to any feature in embodiments and implementations of the present disclosure described in the specification and claims. The use of “a” and “an” does not limit the meaning to a single feature unless such a limit is specifically stated. The term “a” or “an” entity refers to one or more of that entity. As such, the terms “a” (or “an”), “one or more” and “at least one” can be used interchangeably herein.

At least: As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements). The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

Comprising: In the claims, as well as in the specification, all transitional phrases such as “comprising,” “including,” “carrying,” “having,” “containing,” “involving,” “holding,” “composed of,” and the like are to be understood to be open-ended, i.e., to mean including but not limited to.

Embodiments: Reference throughout the specification to “one embodiment,” “an embodiment,” “some embodiments,” “one aspect,” “an aspect,” “some aspects,” “some implementations,” “one implementation,” “an implementation,” or similar construction means that a particular component, feature, structure, method, or characteristic described in connection with the embodiment, aspect, or implementation is included in at least one embodiment and/or implementation of the claimed subject matter. Thus, the appearance of the phrases “in one embodiment” or “in an embodiment” or “in some embodiments” (or “aspects” or “implementations”) in various places throughout the specification are not necessarily all referring to the same embodiment and/or implementation. Furthermore, the particular features, structures, methods, or characteristics may be combined in any suitable manner in one or more embodiments or implementations.

Exemplary: “Exemplary” is used exclusively herein to mean “serving as an example, instance, or illustration.” Any embodiment described herein as “exemplary” is not necessarily to be construed as preferred or advantageous over other embodiments.

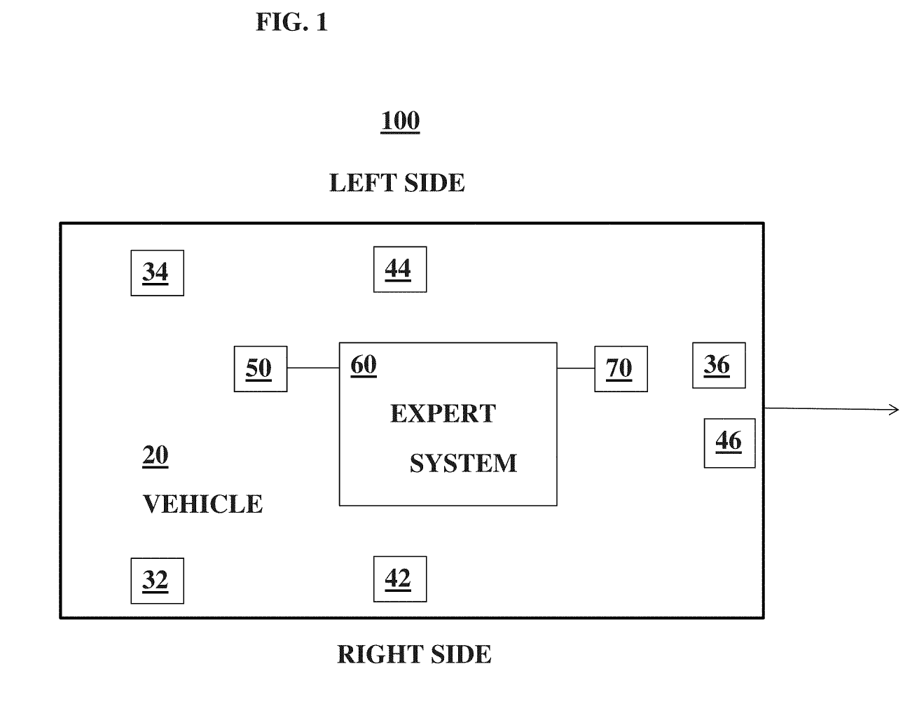

FIG. 1 is a schematic block diagram of a collision warning system 100 of a vehicle 20. The collision warning system 100 includes a hardware Application Program Interface (API) 50, an expert system 60, sensors 80, and an Operator Alert Interface (OAI) (not shown in FIG. 1) of one embodiment of the present disclosure.

Vehicle 20 can be comprised of any kind of vehicles including a car, a bus, a truck, a motorcycle, etc. For the exemplary purpose only, a transit bus will be interchangeably used with vehicle 20 hereinafter along with a reference number 20. Transit bus 20 may travel in a forward direction as indicated by the arrow of FIG. 1. The sensors 80 may include thermal video sensors 32, 34, and 36 and laser range scanners 42, 44, and 46. Specifically the thermal video sensors 32, 34, and 36 may include a right-side thermal video sensor 32, a left-side thermal video sensor 34, and a front thermal video sensor 36. Additional thermal video sensors (not shown) may be provided at the rear, or near a passenger door, or at other useful locations (such as the front right corner or the front left corner). The thermal video sensors 32, 34, and 36 may be mounted high on the transit bus 20 and be pointed partially downward.

The laser range scanners 42, 44, and 46 may include a right-side laser range scanner 42, a left side laser range scanner 44, and a front laser range scanner 46. The laser range scanners may also detect velocity of objects (relative to the vehicle) and additional laser range scanners may be present.

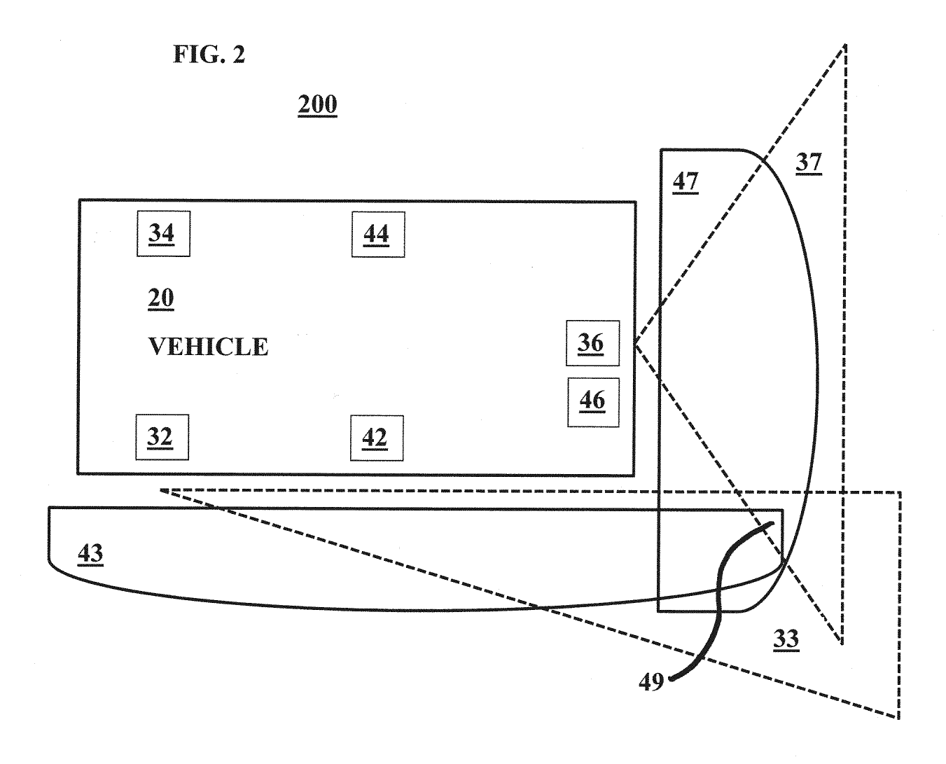

FIG. 2 is a schematic block diagram 200 of the vehicle 20 illustrating coverage of various sensors 32, 34, 36, 42, 44, and 46 of one embodiment of the present disclosure. Specifically, the right-side thermal video sensor 32 covers an right-side thermal area 33, the front thermal video sensor 36 covers a front thermal area 33, the right-side laser range scanner 42 covers a right-side laser area 43, and the front laser range scanner 46 covers a front laser area 47.

As illustrated in FIG. 2, the areas covered by the sensors may overlap. For example, front thermal area 37 substantially overlaps with front laser area 47 to create a front overlap area. Right-side thermal area 33 substantially overlaps with right-side laser area 43 to create a side overlap area. In some configurations, more than two sensed areas may overlap. For example, areas 37, 47, 33, and 43 may all overlap in a “four-fold overlap” area 49 that is in front of the vehicle 20 and to the right of the vehicle 20. This four-fold overlap is particularly useful for transit buses in the United States (and in other countries with vehicles that drive on the right hand side of the road) as they pull into or pull out of bus stops, and as they make right hand turns at intersections. Although only one (1) four-fold overlap area 49 is described in FIG. 2, every four (4) corner may have the four-fold overlap area by the coverage of various sensors 32, 34, 36, 42, 44, and 46 or any additional sensors (not shown).

In one embodiment, the right-side laser range scanner 42 is mounted a few feet above the ground, near the center of the right side of the vehicle 20. The left side laser range scanner 44 is mounted a few feet above the ground, near the center of the left side of the vehicle 20. The front laser range scanner 46 is mounted a few feet above the ground, near the center of the front of the vehicle 20. Additionally, right-side thermal video sensor 32 is mounted near the roof (or on the roof), near the rear, and at the right side of the vehicle 20 (and pointed substantially forward and partially downward). The left side thermal video sensor 44 is mounted near the roof (or on the roof), near the rear, and at the left side of the vehicle 20 (and pointed substantially forward and partially downward). The front laser range scanner 46 is mounted near the roof (or on the roof), near the middle, and at the front of the vehicle 20.

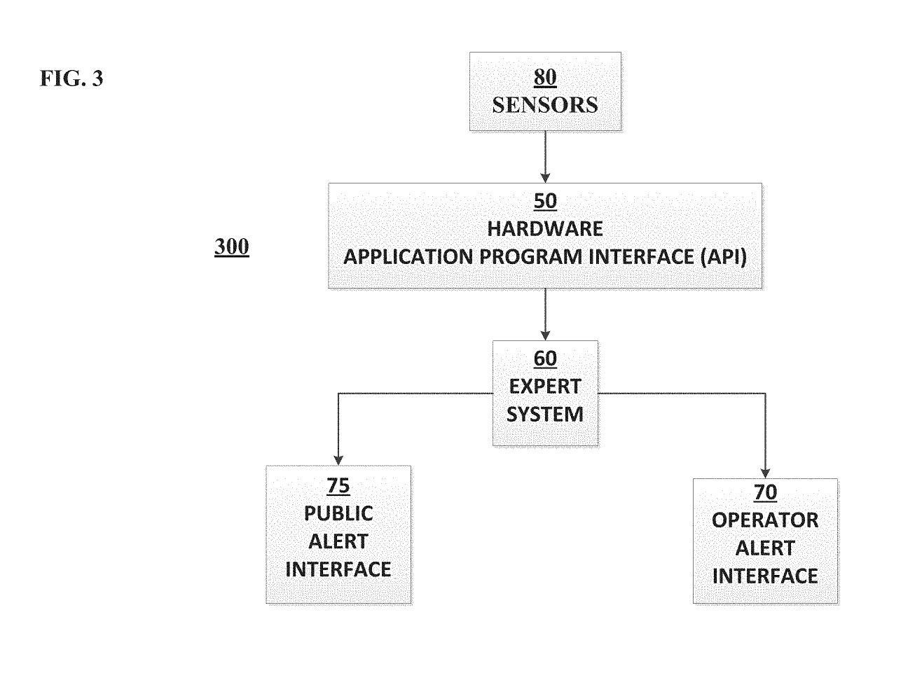

FIG. 3 is a schematic block diagram of components 50, 60, 70, 75, and 80 of the pedestrian collision warning system 300 of one embodiment of the present disclosure.

The pedestrian collision warning system may comprise a number of hardware sensors and software (instructions stored in non-transitory computer readable media) components interconnected in a modular architecture for real-time execution. The overall data acquisition and processing framework is shown in the figures. The architecture enables a unified solution for both frontal and side collision predictions and warnings. All of the system components (instructions stored in non-transitory computer readable media and/or hardware) may communicate over wired and/or wireless Internet protocol (IP), thus simplifying interconnectivity and installation during development and final deployment.

Situational awareness may be developed and analyzed by capturing and processing data from the surroundings as well as from the vehicle using the sensors listed below.

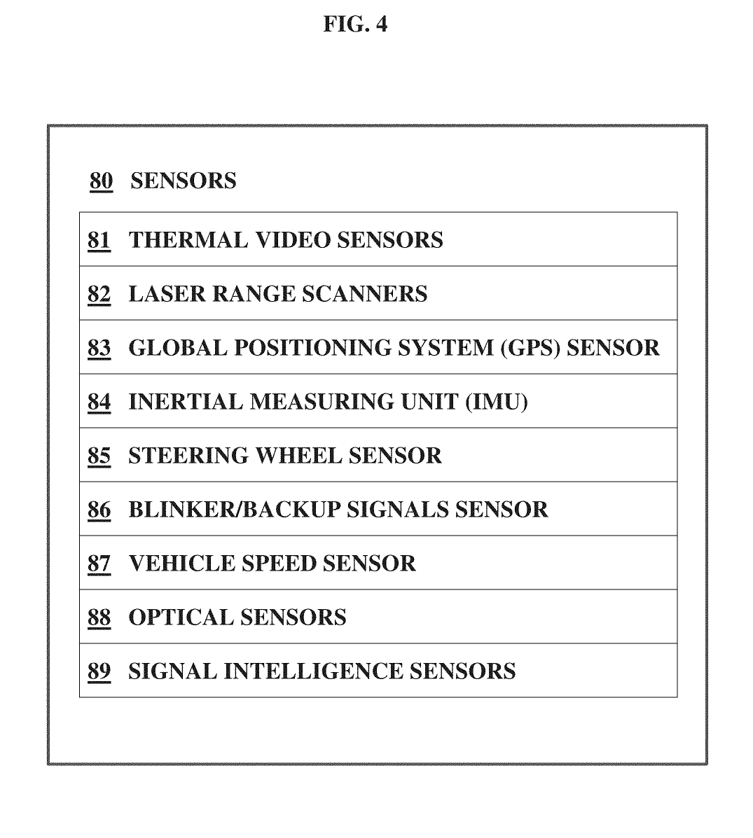

Specifically, sensors 80 may include the thermal video sensors 32, 34, and 36 and the laser range scanners 42, 44, and 46 previously discussed, as well as additional sensors (discussed below regarding FIG. 4). Hardware application program interface (API) 50 may connect sensors 80 to expert system 60. Operator Alert Interface (OAI) 70 transmits information from the expert system 60 to a vehicle operator. Public Alert Interface (PAI) 75 transmits information from the expert system 60 to members of the public that may be approaching the vehicle. The Public Alert Interface (PAI) 75 may be located on the vehicle, or may be located external to the vehicle, such as at a bus stop.

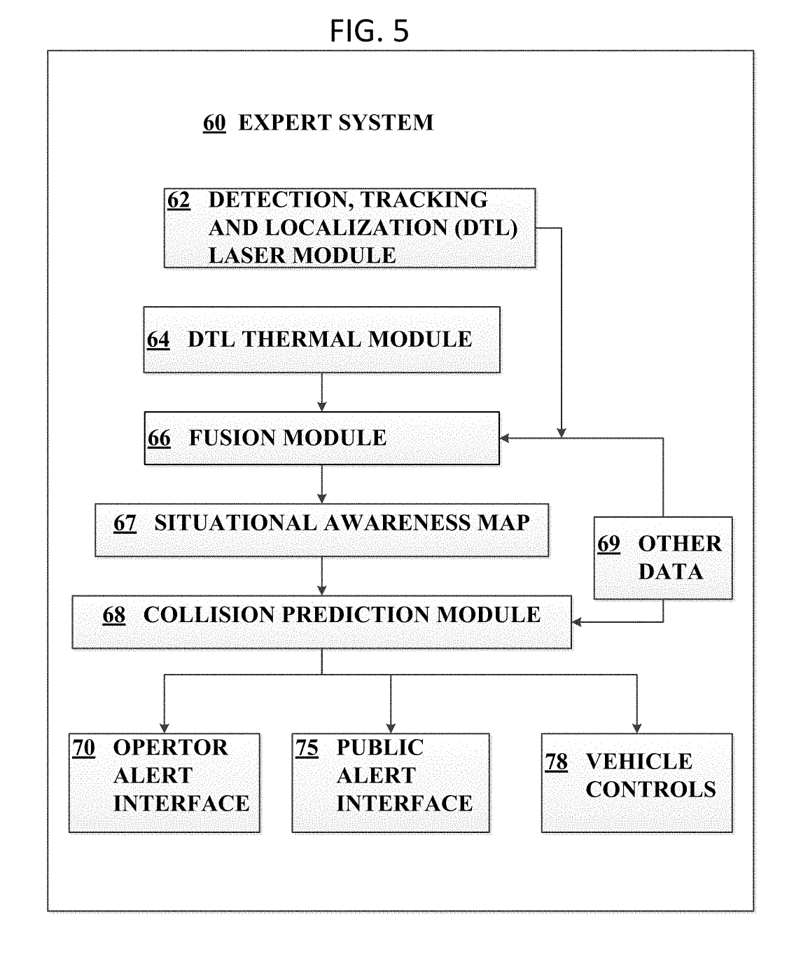

Expert system 60 may include modules (discussed below regarding FIG. 5) that process data from sensors, create a situational awareness map, predict collisions, and generate warnings. The situational awareness map and the warnings may be transmitted to the operator alert interface (OAI) 70 and/or to the public alert interface (PAI) 75.

The operator alert interface (OAI) 70 may include: a display screen (not shown) illustrating a map of the area around the vehicle with various icons representing the vehicle and representing nearby pedestrians; a speaker for broadcasting alarms (such as “brake now” or “pedestrian crossing from the right”); a haptic interface for vibrating the steering wheel (and/or the brake pedal, and/or the accelerator pedal) as a warning; and a horn of the vehicle.

The public alert interface (PAI) 75 may include: an external loudspeaker (not shown) for broadcasting audio alarms (such as “danger, stand back”); a visual alarm such as flashing red light; or a nozzle for spraying water to alert pedestrians.

FIG. 4 is a schematic block diagram of an exemplary and non-limiting list of sensors 80. The sensors 80 may include: thermal video sensors 81 as described above (32, 34, and 36), laser range scanners 82 as described above (42, 44, and 46) and optionally detecting velocity relative to the vehicle), a global positioning system (GPS) sensor 83, an inertial measuring unit (IMU) 84, a steering wheel sensor 85, a blinker/black-up signals sensor 86, a vehicle speed sensor 87 (directly measured by the vehicle), optical sensors 88 (such as a monocular or stereo black and white camera system, or color camera system), signal intelligence sensors 89, and auxiliary measurements sensor (not shown). The signal intelligence sensors 89 may detect electromagnetic signals from external sources such as: cell phones, radios, MP3 players, electrical wheelchairs, and other electronic devices. The sensors 80 may be comprised of any subset of the above listed sensors, and may include sensors not listed above. In particular, the sensors 80 may be constituted without any one or more of a global positioning system (GPS) sensor 83, an inertial measuring unit (IMU) 84, and the auxiliary measurements sensor (not shown).

Thermal video sensors 81 may be used in conjunction with laser range scanners 82 to improve detection and localization of objects in the scene. Thermal cameras (such as FLIR TCX™ Thermal Bullet, not shown) are preferred over standard color cameras due to their ability to function in degraded environments and at night. Moreover, thermal cameras provide a better signature for detecting humans (which are often very challenging to detect) in comparison to using color cameras that frequently generate false alarms for poles and trees.

The thermal video sensors 81 may be installed and positioned (e.g., on a transit bus) in a way to maximize fields-of-view overlap with laser range scanners 82 in order to facilitate information fusion for improved pedestrian detection and localization. For example, see FIG. 2 discussed above.

A GPS sensor 83 provides a vehicle geo-location. This vehicle geo-location may determine the vehicle's location on a map, which is useful for the system to identify its environment (near an intersection, or near a bus stop).

An IMU 84 may be affixed to the vehicle's bed, may establish the vehicle orientation with respect to the road network, and may determine the anticipated motion trajectory of the vehicle 20. The IMU 84 with 9-degrees of freedom usually incorporates three integrated sensors including a MEMS (Micro-ElectroMechanical System) based triple-axis gyro, a triple-axis accelerometer, and a triple-axis magnetometer which collectively provide sufficient information to model the orientation and movement of the vehicle with respect to the environment.

Vehicle sensors (such as steering wheel sensor 85, blinker/backup signals sensor 86, and/or vehicle speed sensor 87) provide optional auxiliary (or additional) measurements from different components of the vehicle 20. These measurements may be obtained directly from a vehicle electronic interface. The auxiliary measurements (such as steering wheel, turn-light status, etc.), when available, can be used to predict the driver's intentions and the expected motions trajectory of the bus. For example, a driver initiated right turn blinker indicates that the driver intends to turn right, or to shift to a lane on the right, or to enter a bus stop region on the right.

System components may be linked via wired (LAN) or wireless (WiFi) connectivity using off-the-shelf networking equipment. Data acquisition and processing may be performed by commercial off-the-shelf processing boards. All of the equipment may be powered from the vehicle's electrical system via an uninterrupted power supply pass through to prevent any hardware failure including rebooting and/or resets during engine shutdown/startup.

Regarding signal intelligence sensors 89, many pedestrians carry electrical equipment (such as cell phones) that generates electromagnetic signals. These electromagnetic signals may be received and triangulated using antennas on the vehicle. Further, many cell phones constantly update and transmit their locations, such that a telecommunications carrier (e.g., Verizon) may know the physical location of many of its cell phones (especially if a GPS application of the cell phone is currently operating). This cell phone generated GPS information may be transmitted to the signal intelligence sensors on the vehicle indirectly via the telecommunications carrier, or directly from the cell phone to the vehicle. In one embodiment, the vehicle “pings” for GPS information from nearby cell phones. For example, the vehicle may be linked to Verizon or Google Maps, then Verizon or Google Maps may identify any cell phones near the vehicle (or identify other vehicles that are nearby), and then Verizon or Google Maps may send location information of those cell phones to the vehicle. In another embodiment, the vehicle may communicate directly with nearby cell phones (or nearby vehicles). In yet another embodiment, the location information may also include physical handicap information such as blindness or deafness of the cell phone user so that the vehicle may customize warnings (blasting a horn will not alert a deaf person, and the vehicle may utilize this information). Also, if a cell phone is being used to play a game (or talk on the phone, or cruise the Internet), then the vehicle may be notified that the user of the cell phone may be distracted and may require extra caution.

Further, sensors may be permanently located at danger areas such as bus stops and intersections, and these sensors may communicate with the vehicle as the vehicle approaches the bus stop or intersection.

FIG. 5 is a schematic block diagram illustrating some modules of the expert system 60. Modules are hereby defined in the specification and claims as hardware, or circuit, or instructions stored on a non-transitory computer readable medium, or a combination of hardware and of instructions stored on a non-transitory computer readable medium.

There may be 4 modules: a detection, tracking, and localization (DTL) laser module 62, a detection, tracking, and localization (DTL) thermal module 64, a fusion module 66, and a collision prediction module 68.

In FIG. 5, the detection, tracking, and localization (DTL) laser module 62 receives an input sensor stream (laser data) from the laser range scanners 82, and detects, tracks, and localizes objects of interest using this laser data. The output of this DTL laser module 62 may include groups of laser returns in a given frame, wherein each group ideally corresponds to an object in the world. For each group, the DTL laser module 62 may output a first unique identifier that remains the same for at least a duration during which the object is detected. Additionally, the DTL laser module 62 may output a position and a velocity of each object using a vehicle coordinate system (relative to the vehicle) and/or using a geo coordinate system.

Similarly, a detection, tracking, and localization (DTL) thermal module 64 receives an input sensor stream (thermal data) from the thermal video sensors 81, and detects tracks, and localizes objects of interest using this thermal data. The output of this DTL thermal module 64 may include groups of thermal returns in a given frame, wherein each group ideally corresponds to an object in the world. For each group, the DTL thermal module 64 may output a second unique identifier that remains the same for at least the duration during which the object is detected. Further, the DTL thermal module may output a bounding box in an image-space (such as a rectangle in a 2-dimensional space, or a cube in a 3-dimensional space) around each detected object and may output the second unique identifier of the detected object. Additionally, the DTL thermal module may output a position and velocity of each object in a bus coordinate system (relative to the bus) or in a geo coordinate system.

The fusion module 66 may receive and then fuse (or integrate) information from the DTL laser module 62 and the DTL thermal module 64 to generate a situational awareness map 67 providing the position and velocity of each detected object (probable pedestrian or cyclist) in the bus coordinate system (or in a geo coordinate system) and in an image space. This situational awareness map 67, along with other data 69 (such as GPS, IMU, and other measurements) may be input to the collision prediction module 68.

The other data 69 may also include physical data such as a detailed physical map identifying permanent objects (such as telephone poles, curbs, and benches at a bus stop). The other data 69 may also include historical accident data from previous accidents that occurred at the same location, or at similar locations.

For example, if a pedestrian stumbled over a certain curb at 11:30 PM on a Friday night at a certain location and collided with a bus last year, then the collision predictor module 68 may consider this historical accident data as part of its collision prediction process. For example, the collision prediction module 68 may attach greater importance to potential pedestrian detections late on Friday nights, and/or near the actual location where the previous accident occurred, and/or near curbs that are similar to where the previous accident occurred. The historical accident data may be regularly updated. The fusion module 66 may also use this historical accident data in a similar fashion (e.g., accepting a higher risk of false positive detections of pedestrians under certain conditions).

Additionally, the fusion module 66 may consider the detailed physical map to help generate the situational awareness map. For example, known telephone poles may be compared with potential detected pedestrians (at or near the location of the known telephone pole), and some of the potential detected pedestrians may be identified/excluded as known telephone poles (instead of as pedestrians).

As described above, the collision prediction module 68 may use the situational awareness map 67 and other data 69 to predict collisions. Information about predicted collisions (including warnings) may be output to an operator alert interface (OAI) 70, to a public alert interface (PAI) 75, and/or to vehicle controls 78 (such as vehicle brakes).

For example, the operator alert interface (OAI) 70 may provide audio instructions (such as “be careful, pedestrian approaching from the right”), or audio alarms (such as a beeping that increases in frequency and in loudness as the risk of collision increases), or haptic alarms (such as vibrating the steering wheel).

The audio instructions may increase in volume, or in tone, or in specific wording as the probability of collision increases. For example, a first audio instruction may be a gentle “be careful,” then a second audio instruction may be a firm “please brake now,” and finally a third audio instruction may be a loud and repetitive “Brake hard! Brake hard! Brake hard!” Any one of these audio instruction may be broadcast by the operator alert interface (OAI) 70 as a single instruction, or may be broadcast as a series of instruction if the first instruction does not mitigate or resolve the danger of collision.

Further, the operator alert interface (OAI) 70 may include a visual display (not shown) of at least a portion of the situational awareness map. This visual display may display detected pedestrians (and/or cyclists) as various icons, and may indicate pedestrians with a high probability of collision as large icons, and/or as red icons, and/or as flashing icons, and/or as boxed icons. Inversely, a pedestrian with a low probability of collision may be displayed as a small icon, and/or as a green icon, or might not be displayed at all (to reduce visual clutter). This visual display may be a “heads up” display that is displayed upon the vehicle windshield (or on a driver's glasses), and may display an icon on the windshield at a windshield location where the driver should look to see the pedestrian that is at risk.

The public alert interface (PAI) 75 may include a directional loudspeaker, a vehicle horn, flashing lights, and may include a nozzle that sprays water towards a detected pedestrian or towards a danger zone. Sprayed water may alert blind pedestrians (that would not see flashing lights) and may alert deaf pedestrians (that would not hear a vehicle horn). Alternately, a combination of flashing lights and a vehicle horn may alert both blind pedestrians and deaf pedestrians. A pedestrian wearing ear plugs and watching a video on his smart phone is extremely distracted, but may be alerted by sprayed water. The nozzle may be permanently directed to a danger zone relative to the vehicle, or may be specifically directed towards a specific pedestrian.

The public alert interface (PAI) 75 may operate simultaneously with the operator alert interface (OAI) 70 in order to warn the public (especially the pedestrian that is at risk) and the vehicle operator simultaneously.

The vehicle controls 78 (such as the vehicle brakes) may be activated by the collision prediction module upon predicting a high probability of a forward collision. In a vehicle 20 with advanced vehicle controls (such as a self-driving vehicle), the vehicle controls may be ordered to turn left by the collision prediction module upon predicting a high probability of collision with the front right corner of the vehicle. The vehicle controls 78 may include a vehicle horn and/or vehicle hazard lights.

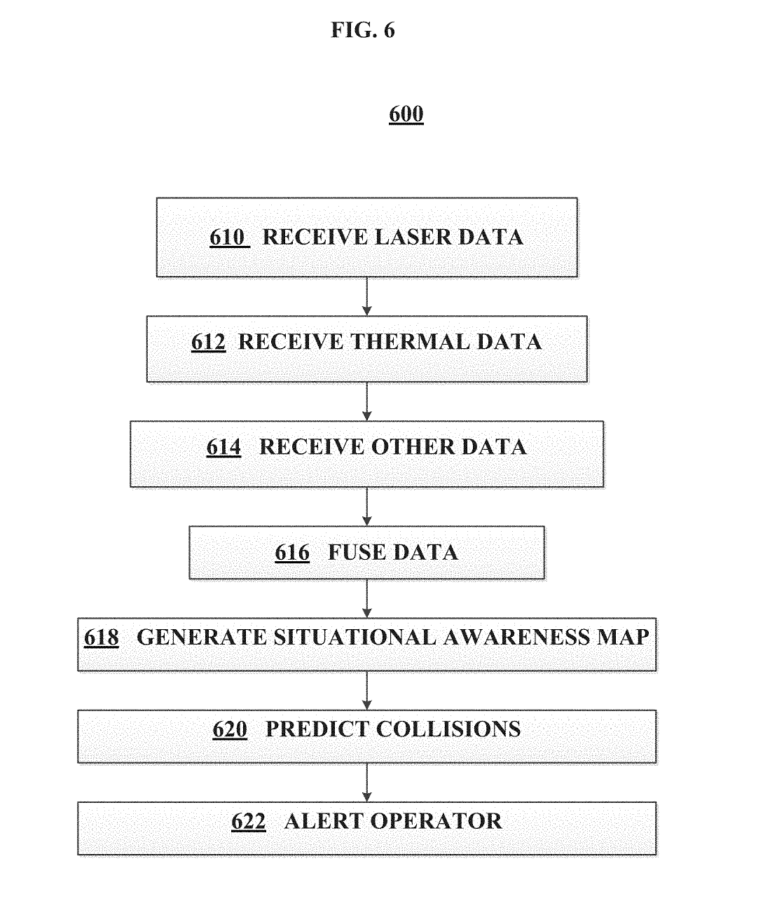

FIG. 6 illustrates a flowchart 600 of one embodiment of the expert system 60.

Step 610 receives laser data from laser range scanners 82, and then performs detection, tracking, and localization upon the laser data to generate laser data output.

Step 612 receives thermal data from thermal video sensors 81 and then performs detection, tracking, and localization upon the thermal data to generate thermal data output.

Optional step 614 receives other data (such as vehicle status data). These receiving steps may occur in any order.

Step 616 fuses the generated laser data output and generated thermal data output. For example, thermal data output can be used to exclude (or to confirm) some potential pedestrians that are indicated by the laser data output.

Step 618 generates a situational awareness map. The situational awareness map may include the vehicle 20 as a frame of reference, and may map nearby identified pedestrians (or cyclists) relative to the vehicle. The situational awareness map may include vector information (such as speed and direction) for the vehicle and for each identified pedestrian.

Step 620 predicts collisions (probability of collision and/or severity of collision) for each pedestrian, based upon the situational awareness map and/or other data such as historical data.

Step 622 alerts the operator (via the operator alert interface 70) when the probability of a collision with a pedestrian (or a cyclist) exceeds a predetermined level. Step 622 may also alert the public via the public alert interface 75. Step 622 may also control the vehicle through the vehicle controls 78 (especially the vehicle brakes) to avoid a collision.

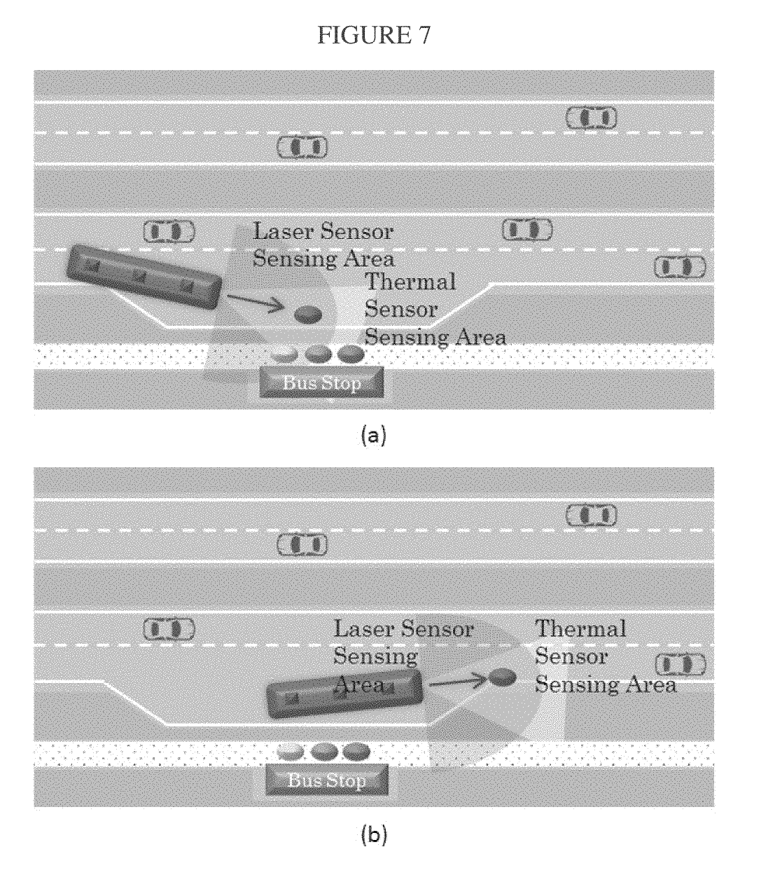

FIG. 7 illustrates accidents that may occur as a transit bus pulls (a) into a bus stop and (b) out of a bus stop. The sensor placement described above in FIG. 2 provides full coverage of pedestrian and cyclist presence around a transit bus and is able to detect a wide variety of collision scenarios involving pedestrians/cyclists and transit buses. Two of the primary scenarios that encompass a majority of accidents between transit buses and pedestrians involve bus stops and turns at intersections.

In FIG. 7, the system needs to observe and monitor pedestrians (depicted by small ovals) or cyclists who may in the direct trajectory of motion of the bus. In these scenarios, a pedestrian may be detected by both the front thermal video sensor 36 (also known as an IR sensor) and by front laser range scanner 46. The front thermal video sensor is particularly useful for classifying (and/or for confirming) a detected object as a pedestrian, and the front laser range scanner is particularly useful for estimating the distance and relative position of the pedestrian (relative to the vehicle) for assessing a risk of collision. Note, FIG. 7 (and all of the other drawings) are not necessarily to scale.

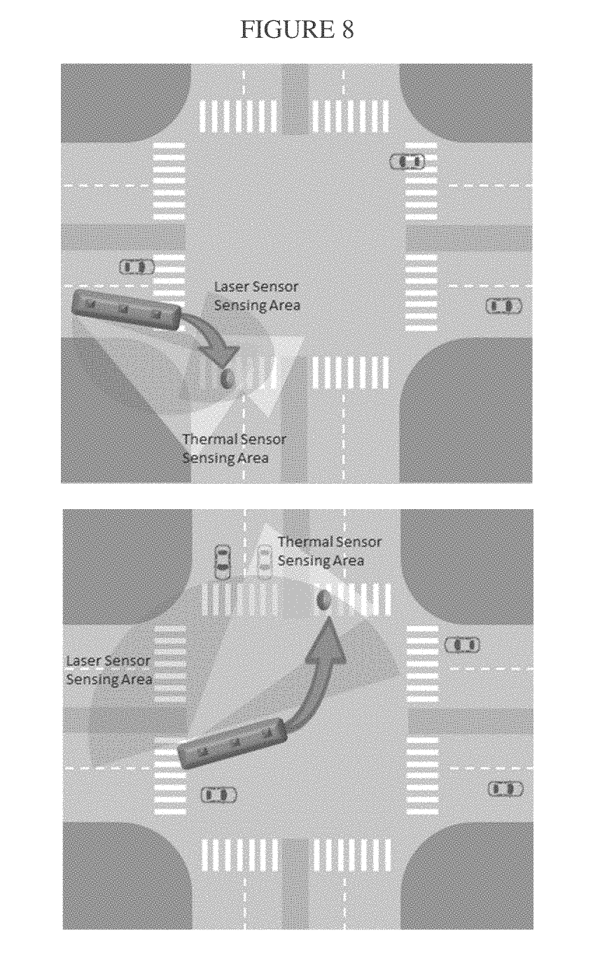

FIG. 8 illustrates accidents that may occur at an intersection while a bus is turning (a) to the right, or (b) to the left. This pictures illustrate intersections at countries such as the United States where vehicles travel on the right side of the road.

The bottom portion of FIG. 8 illustrates a right hand turn at an intersection. In this example, a pedestrian (the oval object) at a crosswalk may be located in an area monitored by multiple sensors, as discussed above regarding FIG. 2. For example, front thermal area 37 substantially overlaps with front laser area 47 to create a front overlap area. Right-side thermal area 33 substantially overlaps with right-side laser area 43 to create a side overlap area. Additionally, areas 37, 47, 33, and 43 may all overlap in a “four-fold overlap” area 49 that is in front of the vehicle and to the right of the vehicle. This four-fold overlap is particularly useful for transit buses in the United States (and in other countries that drive on the right hand side of the road) as they pull into or pull out of bus stops, and as they make right hand turns at intersections. The pedestrian in the bottom portion of FIG. 8 is located in this four-fold overlap area, and is easily detected with a low probability of a false positive detection (a low probability of a false alarm).

The top portion of FIG. 8 illustrates a bus making a left hand turn with a pedestrian (indicated by an oval object in the figure) located on a crosswalk. Referring to FIG. 2, left side thermal video sensor 34 and left side laser range scanner 44 may simultaneously detect the pedestrian during a left hand turn at an intersection. This pedestrian may or may not be in a four-fold overlap area. However, this pedestrian is at least in an overlap area covered by both the left-side thermal video sensor 34 and the left-side laser range scanner 44, facilitating the accurate detection of this pedestrian.

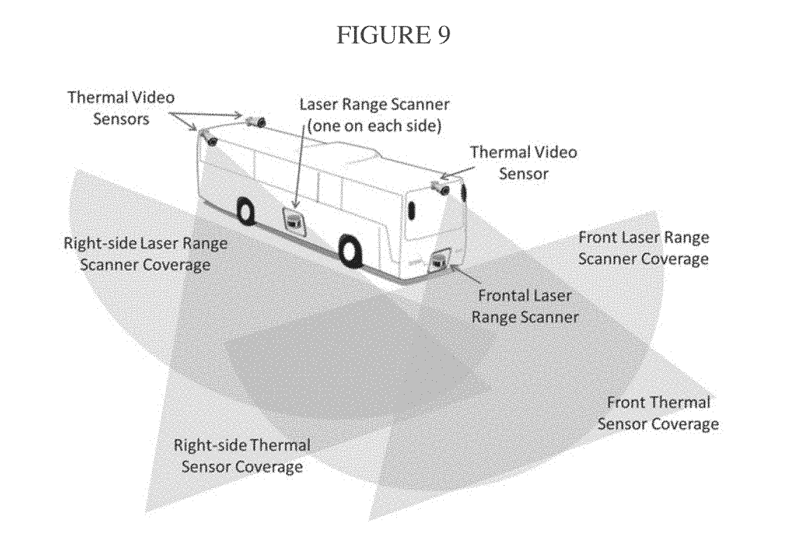

FIG. 9 illustrates a perspective view of the sensor configuration described above in FIGS. 1 and 2.

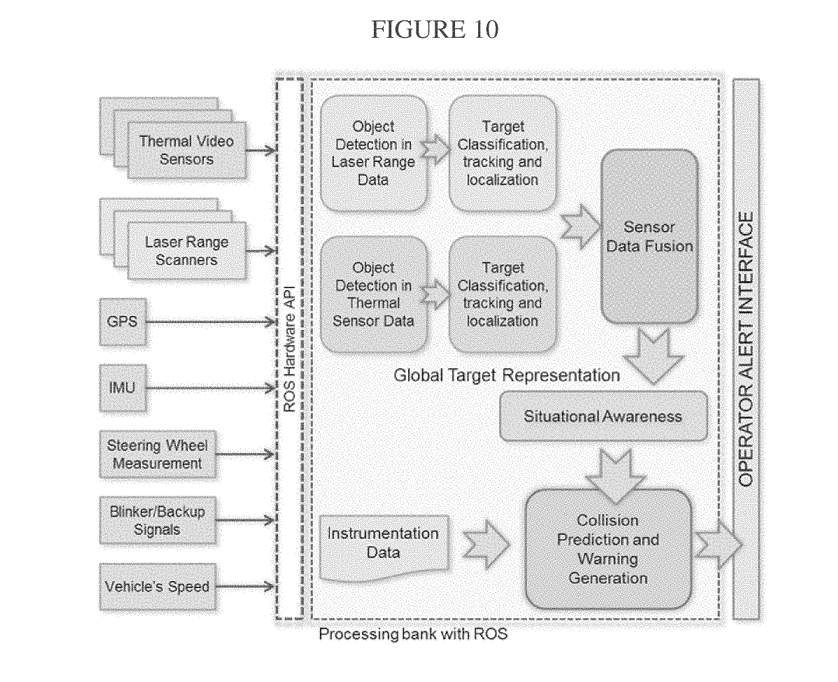

FIG. 10 illustrates one embodiment of the collision warning system described in FIGS. 3-6.

It is to be understood that the exemplary embodiments described herein are that for presently preferred embodiments and thus should be considered in a descriptive sense only and not for purposes of limitation. Descriptions of features or aspects within each embodiment should typically be considered as available for other similar features or aspects in other embodiments.

What is claimed is:

1. A collision prediction and warning system for a predicted collision of a pedestrian or bicyclist with a left side of the transit bus or a right side of the transit bus, the system comprising:
a first range scanner located at a first side of the transit bus and arranged to cover a first side area providing full coverage of pedestrian and cyclist presence around the transit bus on the first side of the transit bus, wherein the first side is one of the left side of the transit bus or the right side of the transit bus;
a first DTL (detection, tracking and localization) module configured to detect, track, and localize a first object corresponding to the pedestrian or bicyclist based on at least first range scanner data received from the first range scanner, and output first detected object information including a position of the first object;
a first video sensor located at the first side of the transit bus and in close proximity to a rear of the transit bus, pointed substantially forward, and arranged to cover a second side area along the first side of the transit bus, the second side area overlapping the first side area;
a second DTL module configured to detect, track, and localize a second object corresponding to the pedestrian or bicyclist based on at least first image data received from the first video sensor, and output second detected object information including a position of the second object;
a fusion module configured to determine a first position of the pedestrian or bicyclist based on at least positions of objects included in the first detected object information output by the first DTL module and the second detected object information output by the second DTL module;
a collision prediction module configured to:
estimate a likelihood of collision between the detected pedestrian or bicyclist and the first side of the transit bus based on at least the first position of the pedestrian or bicyclist determined by the fusion module, and
determine that a warning should be presented based on at least the estimated likelihood of collision; and
an operator alert interface configured to present an alert to a human operator of the transit bus in response to the determination that the warning should be presented.

2. The collision prediction and warning system of claim 1, wherein the first video sensor is located in close proximity to a roof of the transit bus and is pointed partially downward.

3. The collision prediction and warning system of claim 2, wherein the first range scanner is located in close proximity to a center of the first side of the transit bus.

4. The collision prediction and warning system of claim 3, further comprising a second video sensor located at a front side of the transit bus and arranged to cover a first front area in front of the transit bus, wherein:
the second DTL module is configured to detect, track, and localize a third object based on at least second image data received from the second video sensor and include a position of the third object in the first detected object information; and
the second side area overlaps the first front area.

5. The collision prediction and warning system of claim 4, further comprising a second range scanner located at the front side of the transit bus and arranged to cover a second front area in front of the transit bus, the second front area overlapping the first front area, the first side area, and the second side area, wherein:
the first video sensor is a thermal video sensor and the first image data includes first thermal data;
the first DTL module is configured to configured to detect, track, and localize a fourth object corresponding to the pedestrian or bicyclist based on at least second range scanner data received from the second range scanner and include a position of the fourth object in the first detected object information;
the second DTL module is configured to detect, track, and localize the second object based on at least the first thermal data received from the first video sensor; and
the third object corresponds to the pedestrian or bicyclist.

6. The collision prediction and warning system of claim 1, wherein the collision prediction module is further configured to:
receive a turn-light status and/or a steering wheel movement measurement indicating the transit bus is turning or will be turning;
predict an expected motion trajectory of the transit bus based on at least the turn-light status and/or the steering wheel movement measurement; and
estimate the likelihood of collision based on at least the expected motion trajectory of the transit bus and the first position of the pedestrian or bicyclist determined by the fusion module.

7. The collision prediction and warning system of claim 1, wherein the collision prediction module is configured to:
obtain a current location of the transit bus;
determine, based on historical accident data, that a location at which a previous accident occurred between a pedestrian and a vehicle is the same or similar to the current location of the transit bus; and
estimate the likelihood of collision based on at least the first position of the pedestrian or bicyclist determined by the fusion module and the determination that the location of the previous accident is the same or similar to the current location of the transit bus.

8. The collision prediction and warning system of claim 7, wherein the collision prediction module is configured to:
determine that a current time and day corresponds to a time and day at which the previous accident occurred; and
estimate the likelihood of collision based on at least:
the first position of the pedestrian or bicyclist determined by the fusion module,
the determination that the location of the previous accident is the same or similar to the current location of the transit bus, and
the determination that the current time and day corresponds to the time and day at which the previous accident occurred.

9. The collision prediction and warning system of claim 1, wherein:
the collision prediction and warning system is configured to triangulate electromagnetic signals received by antennas on the transit bus from an electrical wheelchair or an electronic device carried by the pedestrian or bicyclist; and
the fusion module is configured to determine the first position of the pedestrian or bicyclist based further on the triangulation of the received electromagnetic signals.

10. The collision prediction and warning system of claim 1, further comprising a public alert interface configured to broadcast an audio alarm via an external loudspeaker or present a visual alarm to the pedestrian or bicyclist in response to the determination that the warning should be presented.

11. A method for alerting a human operator of a transit bus of a predicted collision of a pedestrian or bicyclist with a left side of the transit bus or a right side of the transit bus, the method comprising:
receiving first range scanner data from a first range scanner located at a first side of the transit bus and arranged to cover a first side area providing full coverage of pedestrian and cyclist presence around the transit bus on the first side of the transit bus, wherein the first side is one of the left side of the transit bus or the right side of the transit bus;
receiving first image data from a first video sensor located at the first side of the transit bus and in close proximity to a rear of the transit bus, pointed substantially forward, and arranged to cover a second side area along the first side of the transit bus, the second side area overlapping the first side area;
detecting and tracking the pedestrian or bicyclist based on at least the first range scanner data and the first image data;
estimating a likelihood of collision between the detected pedestrian or bicyclist and the first side of the transit bus based on at least the tracking of the pedestrian or bicyclist;
determining that a warning should be presented based on at least the estimated likelihood of collision; and
presenting an alert to the human operator in response to the determination that the warning should be generated.

12. The method of claim 11, wherein the first video sensor is located in close proximity to a roof of the transit bus and is pointed partially downward.

13. The method of claim 12, wherein the first range scanner is located in close proximity to a center of the first side of the transit bus.

14. The method of claim 13, further comprising:
receiving second image data from a second video sensor located at a front side of the transit bus and arranged to cover a first front area in front of the transit bus; and
detecting and tracking objects based on at least the second image data, wherein:
the second side area overlaps the first front area.

15. The method of claim 13, further comprising:
receiving second range scanner data from a second range scanner located at the front side of the transit bus and arranged to cover a second front area in front of the transit bus, the second front area overlapping the first front area, the first side area, and the second side area, wherein:
the detecting an tracking objects is further based on the second range scanner data,
the first video sensor is a thermal video sensor and the first image data includes first thermal data, and
the detecting and tracking the pedestrian or bicyclist is based on at least the first thermal data and the first range scanner data.

16. The method of claim 11, further comprising:
receiving a turn-light status and/or a steering wheel movement measurement indicating the transit bus is turning or will be turning; and
predicting an expected motion trajectory of the transit bus based on at least the turn-light status and/or the steering wheel movement measurement,
wherein the estimating the likelihood of collision is further based on the expected motion trajectory of the transit bus.

17. The method of claim 11, further comprising:
obtaining a current location of the transit bus; and
determining, based on historical accident data, that a location at which a previous accident occurred between a pedestrian and a vehicle is the same or similar to the current location of the transit bus,
wherein the detecting the pedestrian or bicyclist or the estimating the likelihood of collision is further based on the determination that the location of the previous accident is the same or similar to the current location of the transit bus.

18. The method of claim 17, wherein the detecting the pedestrian or bicyclist or the estimating the likelihood of collision is further based on a current time and day corresponding to a time and day at which the previous accident occurred.

19. The method of claim 11, further comprising:
triangulating electromagnetic signals received by antennas on the transit bus from an electrical wheelchair or an electronic device carried by the pedestrian or bicyclist,
wherein the detecting the pedestrian or bicyclist is based on the triangulation of the received electromagnetic signals.

20. The method of claim 11, further comprising broadcasting an audio alarm via an external loudspeaker or presenting a visual alarm to the pedestrian or bicyclist in response to the determination that the warning should be presented.
